(19) United States
(12) Patent Application Publication
(10) Pub. No.: US 2014/0363576 A1
(43) Pub. Date: Dec. 11, 2014

(54) PERMANENT SIGNATURE APPLICATOR AND METHOD OF USE

(71) Applicant: Karen Formica, Green Brook, NJ (US)

(72) Inventor: Karen Formica, Green Brook, NJ (US)

(21) Appl. No.: 13/912,607

(22) Filed: Jun. 7, 2013

(51) Int. Cl. B41M 5/03

(52) U.S. Cl. CPC B41M 5/03
USPC 427/256; 428/408

(57) ABSTRACT

A credit card signature applicator comprising a strip of material placed over a signature portion of a credit card; and a permanent transfer ink layer on an underside of the strip of material, where the permanent transfer ink layer creates a duplicate signature on the signature portion of the credit card after a user signs their original signature on the strip of material. The signature applicator may be a single-use material available in packs for repeated application. After use of the signature applicator, the user removes the signature applicator to reveal the duplicate signature on the signature portion created by the permanent transfer ink layer on the underside of the signature applicator.

### BACKGROUND OF THE INVENTION

1. Field of the Invention

The present invention relates to an applicator to permanently affix a signature to the signature strip on the back of a credit card.

2. Description of Related Art

Credit cards are monetary devices carried by most people, as a way to purchase goods and services without using physical cash. Credit cards are available from banks, consumer retailers, credit card companies, and even airlines. They are convenient to the purchaser because it allows them to not have to carry money all the time, and instead purchase their items with a simple swipe of the card. In general, on the front side of the credit cards is the issuer's logo, user's name, personal identification number or credit card number, credit card brand logo and expiration date. On the backside are a magnetic strip, signature strip, and the card security code. Several personal identification numbers are associated with the user's credit card to ensure security of the card especially when using the card online when the physical card is not seen by the retailer.

A problem commonly associated with most credit cards is that the signature written on the signature strip often fades or disappears after repeated use of the card. Many individuals use dark pens and even permanent markers to write their signatures, but they still fade even after just a few uses. Without a signature on the signature strip the user must provide additional identification to the retailer which may become burdensome to continuously provide a second form of identification when trying to make a purchase. It is often a purchasing delay and annoyance for both the consumer and the retailer.

Therefore, it would be desirable in the art to provide a signature applicator that creates a permanent marking on the signature strip of a credit card. It would also be beneficial in the art to provide a signature applicator that is easy to use for convenience to the consumer.

### SUMMARY OF THE INVENTION

In view of the foregoing disadvantages inherent in the prior art, the general purpose of the present invention is to provide a signature applicator to apply a permanent signature to a credit card, configured to include all of the advantages of the prior art, and to overcome the drawbacks inherent therein.

Accordingly, an object of the present invention is to provide a signature applicator that copies a permanent duplicate signature of a user's original signature onto the signature portion of a credit card.

Another object of the present invention is to provide a signature applicator that is a single-use material to enable easy application and disposal of the applicator.

To achieve the above objects, in an aspect of the present invention, a credit card signature applicator is described comprising a strip of material placed over a signature portion of a credit card; and a permanent transfer ink layer on an underside of the strip of material, where the permanent transfer ink layer creates a duplicate signature on the signature portion of the credit card after a user signs their original signature on the strip of material. The signature applicator may be a single-use material available in packs for repeated application. After use of the signature applicator, the user removes the signature applicator to reveal the duplicate signature on the signature portion created by the permanent transfer ink layer on the underside of the signature applicator.

These together with other aspects of the present invention, along with the various features of novelty that characterize the present invention, are pointed out with particularity in the claims annexed hereto and form a part of this present invention. For a better understanding of the present invention, its operating advantages, and the specific objects attained by its uses, reference should be made to the accompanying drawings and descriptive matter in which there are illustrated exemplary embodiments of the present invention.

### BRIEF DESCRIPTION OF THE DRAWINGS

The advantages and features of the present invention will become better understood with reference to the following detailed description and claims taken in conjunction with the accompanying drawing in which:

FIG. 1 depicts a backside view of a credit card with a signature applicator in accordance with an exemplary embodiment of the present invention.

### DETAILED DESCRIPTION OF THE DRAWINGS

The present invention relates to an applicator to permanently affix a signature to the signature strip on the back of a credit card. The present invention provides a signature applicator as a way to permanently and securely apply a duplicate signature to a credit card. The signature applicator includes a removable strip that copies a duplicate signature onto the signature portion of the credit card. The duplicate signature is permanent and will not smudge or rub off after repeated use.

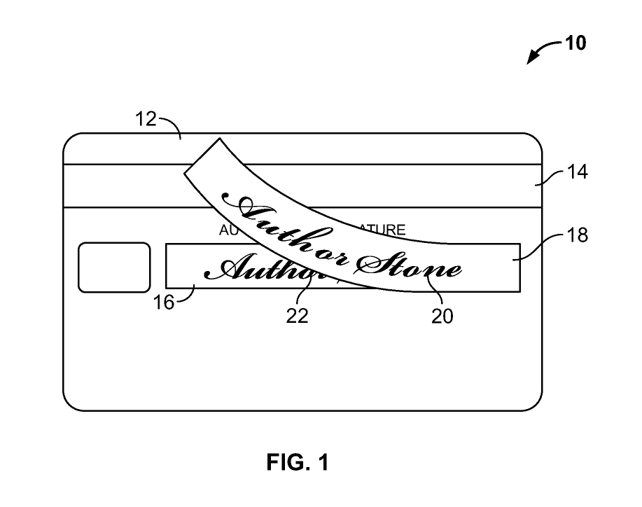

Turning now descriptively to the drawing, referring to FIG. 1, a back side view of a credit card 10 is shown with a signature applicator 18 in accordance with an exemplary embodiment of the present invention. The back surface 12 of the credit card 10 is illustrated including the magnetic strip 14 and the signature portion 16. Positioned above the signature portion 16 is a signature applicator 18. The signature applicator 18 may be a single-use strip of material that overlaps the signature portion 16 of the credit card 10. The strip of material copies a duplicate signature 22 of a user's original signature 20, which the user writes on the signature applicator 18, onto the signature portion 16 of the credit card 10. The duplicate signature 22, created by a permanent transfer ink layer on the underside of the signature applicator 18, will not smudge, fade or disappear for an extended period of time. After the extended period of time, if the duplicate signature 22 has faded, another signature applicator 18 may be used to reapply a new duplicate signature 22.

The signature applicator 18 may be available in packs of multiple single-use applicators 18. This way if the duplicate signature 22 fades a new one may be applied as needed by simply placing a new signature applicator 18 over the signature portion 16 of the credit card 10, signing an original signature 20, then peeling away signature applicator 18 to reveal the duplicate signature 22. The material used for the signature applicator 18 may be a carbon paper that easily transfers the original signature 20 to the signature portion 16. After use the signature applicator 18 is easily discarded, and preferably shredded to remove evidence of the user's original signature 20. The signature applicator 18 may also come already attached to the back surface 12 of the credit card 10 after issue from the bank or Credit Card Company. This way the signature applicator 18 is readily available for immediate use by the user.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

What is claimed is:

1. A credit card signature applicator comprising:
a. a strip of material placed over a signature portion of a credit card; and
b. a permanent transfer ink layer on an underside of the strip of material, where the permanent transfer ink layer creates a duplicate signature on the signature portion of the credit card after a user signs their original signature on the strip of material.

2. The credit card signature applicator according to claim 1, where the signature applicator is a single use material.

3. The credit card signature applicator according to claim 2, where the single-use signature applicator is available in a pack of multiple signature applicators.

4. The credit card signature applicator according to claim 1, where the permanent transfer ink is a carbon material.

5. A method of using a signature applicator for a credit card comprising the steps of:
a. signing an original signature on the signature applicator positioned over a signature portion of a back surface of a credit card;
b. removing the signature applicator; and
c. revealing a duplicate signature on the signature portion created by a permanent ink layer on an underside of the signature applicator.

6. The method of using the signature applicator for a credit card according to claim 5 further comprising the step of reapplying a new signature applicator when the duplicate signature fades.

7. The method of using the signature applicator for a credit card according to claim 5 further comprising the step of applying the signature applicator over the signature portion before signing the original signature.

8. The method of using the signature applicator for a credit card according to claim 5 further comprising the step of discarding the signature applicator after removal.

9. The method of using the signature applicator for a credit card according to claim 8 further comprising the step of shredding the signature applicator to remove evidence of the original signature.
